(19) United States
(12) Patent Application Publication
(10) Pub. No.: US 2018/0135603 A1
(43) Pub. Date: May 17, 2018

(54) ETERNAL ENERGY SOURCE FROM SELF-ACTIVE FALLING WEIGHT-UNITS

(71) Applicant: Ezra Shimshi, Atlanta, GA (US)

(72) Inventor: Ezra Shimshi, Atlanta, GA (US)

(21) Appl. No.: 15/354,302

(22) Filed: Nov. 17, 2016

(51) Int. Cl. F03G 3/00

(52) U.S. Cl. CPC F03G 3/00; F03G 7/10

(57) ABSTRACT

The present invention is energy machine of constant imbalance that forces continual rotation in one direction. An embodiment of this instant invention could include upper and lower spindles, outer and inner ratchet-pulleys, multiple sliders, multiple weight-units resembling enclosed-housings having heavy balls, or liquid, that could be positioned into downward slopes along which the balls would roll, or the liquid would flow, in order to line-up along the locked fast descending outer ratchet-pulley-belts and in order to line-up along the locked slow ascending inner ratchet-pulley-belts, whereupon inevitable natural constant imbalance would be created that is capable to overcome any expected frictions while yielding useful energy output.

### BACKGROUND OF THE INVENTION

### a) Field of the Invention

The present invention relates to means for converting potential energy of fast descending outer weights and slow ascending inner, weights to rotational energy.

### b) The Prior Art

Up to now, there where no claims made for converting the potential energy of fast descending outer weight and slow ascending inner weights to rotational energy.

### SUMMARY OF THE INVENTION

The present invention disclose means for converting the potential energy of fast descending outer objects to rotational energy. An embodiment could include one high and one low spindles held by two poles along vertical line, four large and four small wheels rotating with the spindles, four large and four small sliding wheels, two large and two small belts, two large and two small sliding belts, multiple sliding angled teeth and multiple weight-units. Each large belt fits around each pair of the two large wheels. Each small belt fits around each pair of the two small wheels. Each large sliding belt fits around each pair of the large sliding wheels. Each small sliding belt fits around each pair of the small sliding wheels. Each sliding tooth is connected to the respective sliding belt and could be locked or slide on the outer surface of the respective belt in order to convert the wheels and their respective belts into ratchet-pulleys. The weight-units occupy the gap between the two small inner ratchet-pulleys and around the spindles. Each weight-unit resembles en enclosed-housing. Each side of each enclosed-housing is connected to the respective pair of inner sliding tooth and outer locking tooth. Each enclosed-housing has within it heavy balls, or liquid. Each enclosed-housing could be turned into downward slope by the fast rotating large outer belts that would cause the balls to roll, or the liquid to flow, so as to line-up along the locked fast descending large outer belts and to line-up along the locked slow ascending small inner belts, whereupon creating imbalanced energy machine that could overcome any expected frictions and force rotation in one direction that could yield useful and practical energy output.

Since a formation of heavy balls could line-up in equal numbers along the locked outer descending ratchet-pulleys-belts and along the locked slow ascending inner ratchet-pulleys-belts is being presented for review, such formation is constant imbalance that could force continual rotation in one direction.

It is an undisputed fact that the potential energy of fast descending outer balls would force equal number of slow elevated inner balls to ascend and to produce unidirectional rotation.

Therefore, the outer fast descending balls will, in fact, force the inner balls to ascend in a physical process where one slow ascending inner ball crosses the top point of vertical line while one fast descending outer ball crosses the bottom point of the same vertical line at the same time every 180 degrees of continued rotation.

Furthermore, the fast rotating outer belts will, in fact, turn the top enclosed-housing into downward slope so as to let the respective balls roll down and line-up along the locked fast descending outer belts while at the same time the fast rotating outer belts will turn the bottom enclosed-housing into downward slope so as to let the respective balls roll down and line-up along the locked slow ascending inner belts and both enclosed-housings completing 180 degrees turn every 180 degrees rotation.

### BRIEF DESCRIPTION OF THE DRAWINGS

This instant invention will be more readily understood with reference to the description taken with the related drawings.

Parts and each designated number in FIG. 1 and FIG. 2 are: Frame/Poles 5; Spindles 6; Inner small wheels 7; Outer large wheels 8; Inner small belts 9; Outer large belts 10; Weight-units/Enclosed-housings/Round-objects/Balls/Liquid 11; Sliders 12; Slider-wheels 12′; Slider-belts 12″; Corridors 13.

FIG. 1 is a drawing of two poles (5), two spindles (6), four inner wheels (7), two inner belts (9), four outer wheels (8), two outer belts (10), inner slider-tooth and outer slider-tooth (12); slider-wheels (12′); slider-Belts (12″); multiple enclosed-housings/balls (11); corridors 13. (Ratchet-ball-bearings could be used as the centers for the ratchet-pulleys).

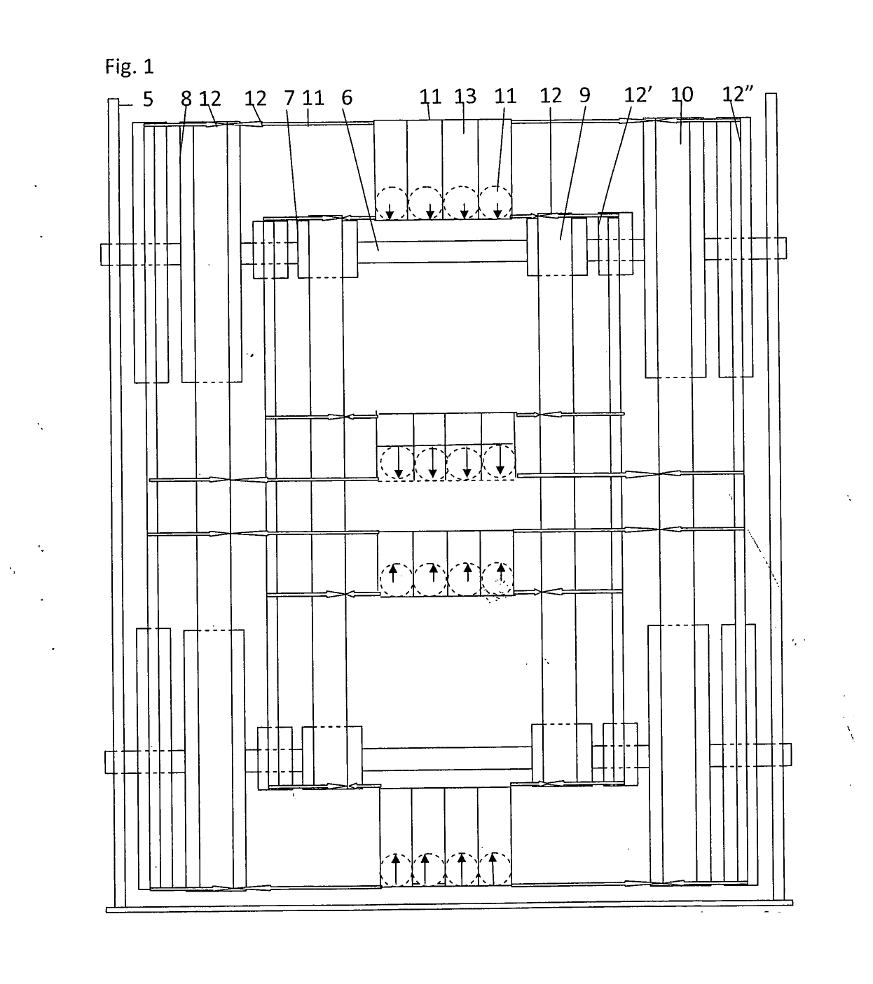

FIG. 2 is schematic view depicting formation of balls (11) in the constant imbalanced machine.

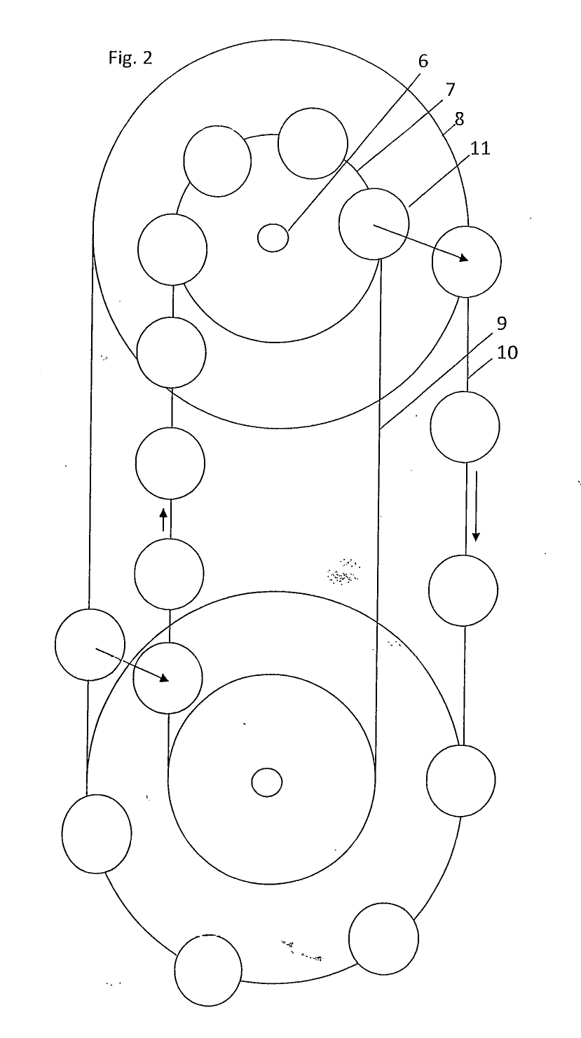

### DESCRIPTION OF AN EMBODIMENT

An embodiment could include two spindles held by a frame, two sets of large outer ratchet-pulleys and two sets of small inner ratchet-pulleys, multiply sliders and multiple enclosed-housings occupying the gap around the spindles and between the small inner ratchet-pulleys sets. Each side of each enclosed-housing is connected to a pair of the respective inner and outer sliders. Each enclosed-housing has within it rolling or flowing objects. Each slider has an angled tooth that could lock or unlock the outer set of the ratchet-pulleys and the inner set of the ratchet-pulleys. The descending enclosed-housings would be turned into downward slopes from the unlocked/sliding slow descending inner ratchet-pulley-belts and toward the locked fast descending outer ratchet-pulley-belts due to the fast rotating outer ratchet-pulley-belts and due to the low center of gravity of the top enclosed housing. The ascending enclosed-housings would be turned into downward slopes from the unlocked/sliding fast ascending outer ratchet-pulley-belts and toward the locked slow ascending inner ratchet-pulley-belts due to the fast rotating outer ratchet-pulley-belts and due to the inertia of the rotating bottom outer balls, whereupon the descending balls will roll downward to line-up along the locked fast descending outer belts and the ascending balls will roll downward to line-up along the locked slow ascending inner belts in order to create constant imbalance between the balls lining along the fast descending outer belts and the balls lining along the slow ascending inner belts.

Such a formations of balls or liquid could include moke and more balls or liquid by simply increasing the length of the outer and inner belts proportionally and/or increasing the vertical distance between the spindles and/or widening the gap between the two sets of the small inner ratchet-pulleys in order to accommodate longer and/or more enclosed-housings filled with more balls or more liquid and thereby increasing the capacity of the constant imbalance to turn a generator of greater output.

While the present invention has been described with references to the mechanism disclosed herein, it is not confined to the detail as set forth, and is not intended in any way to limit the broad features or principles of the present invention or the scope of patent monopoly to be granted. This application is intended to cover any modifications, changes, or improvements that may come within the scope of the claims that follows.

1-19. (canceled)

20. Apparatus for converting potential energy of fast descending outer weights that elevate slow ascending inner weights into rotational energy, comprising poles, spindles, wheels, belts, weight-units and sliders, wherein one spindle held high and one spindle held low by the poles on vertical line, wherein one set of one large slider-outer-belt fitted around two large slider-outer-wheels riding at each side of the spindles, wherein one set of one large outer belt fitted around two large outer wheels riding next at each side of the spindles, wherein one set of one small slider-inner-belt fitted around two small slider-inner-wheels riding next at each side of the spindles, wherein one set of one small inner belt fitted around two small inner wheels riding next at each side of the spindles, wherein the wheels and belts rotate with the spindles, wherein multiple slider-angled-teeth are extended from the large and the small sliding-belts to the respective large and small belts, wherein each respective extended slider-tooth can lock the respective outer surface of each outer belt while each respective extended slider-tooth can slide on the respective outer surface of each inner belt and vise versa every one-half rotation, wherein multiple weight-units resembling enclosed-housings occupy a gap between the two sets of the inner small wheels and belts and around the spindles, wherein each end of each enclosed-housing is connected to the respective pair of sliding and locking teeth, wherein each enclosed-housing has inner corridors with one heavy ball in each corridor.

21. The apparatus for converting potential energy of fast descending outer weights that elevate slow ascending inner weights into rotational energy as in claim 20, wherein as each of the descending enclosed-housings crosses the bottom point of vertical line the fast rotating outer large belts together with the inertia of the bottom outer heavy balls cause each descending enclosed-housing in turn to shift into downward slope high at the fast sliding and ascending large outer belts and down to the locked slow ascending small inner belts, wherein the respective balls roll down from the fast sliding and ascending outer belts to line-up along the locked slow ascending inner belts, wherein as each of the ascending enclosed-housings crosses the top point of the same vertical line the fast rotating outer large belts together with the low center of gravity of the top enclosed-housing cause each ascending enclosed-housing in turn to shift into downward slope high at the slow sliding inner descending belts and down to the locked fast descending outer belts, wherein the respective balls roll down from the inner slow sliding inner descending belts to line-up along the locked fast descending outer belts, wherein each top and bottom enclosed-housings make 180 degrees turn every 180 degrees rotation.

22. The Apparatus for converting potential energy of fast descending outer weights that elevate slow ascending inner weights into rotational energy as in claim 21, wherein the number of balls along the locked fast descending large outer belts is equal to the number of the balls along the locked slow ascending small inner belts, wherein an inevitable natural constant imbalance is created that forces the balls into continual rotation in one direction by overcoming any expected frictions.

23. Energy machine of constant imbalance that forces continual rotation, comprising a frame, two spindles, two sets of large outer ratchet-pulleys, two sets of small inner ratchet-pulleys, multiple sliders and multiple weight-units, wherein one spindle held high by the frame and one spindle held low by the frame along vertical line, wherein the ratchet-pulleys turn with the spindles, wherein a wide gap is between the two small inner ratchet-pulleys sets and around the spindles, wherein a wall of angled teeth are attached along the center line of the outer surface of each belt, wherein equal number of sliders riding each wall of teeth and holding to the sides of the respective walls, wherein each slider has an angled tooth, wherein each respective tooth can lock the outer belts and unlock the inner belts, wherein at the same time each respective tooth can unlock the outer belts and lock the inner belts every one-half rotation, wherein the weight-units resemble enclosed-housings, wherein the enclosed-housings occupy the gap around the spindles, wherein each enclosed-housing contains liquid, wherein each side of each enclosed-housing is connected to the respective pair of inner and outer sliders.

24. The Energy machine of constant imbalance that forces continual rotation as in claim 23, wherein the crossing of the bottom point of vertical line by the fast rotating outer belts and the inertia of the bottom outer liquid would turn each of the descending enclosed-housings that crosses the bottom point of the vertical line into downward slope for the liquid to flow down so as to line-up along the locked slow ascending inner ratchet-pulley-belts, wherein the crossing of the top point of the same vertical line by the fast rotating large outer belts together with the low center of gravity of the top enclosed-housing would turn the top enclosed-housing into a downward slope for the liquid to flow down so as to line-up along the locked fast descending outer ratchet-pulley-belts.

25. The Energy machine of constant imbalance that forces continual rotation as in claim 24, wherein the weight of the descending outer liquid is always equal to the weight of the ascending inner liquid, wherein constant imbalance is created, wherein the constant imbalance forces continual rotation in one direction that overcomes any expected frictions and could yield useful energy.

26. Climate friendly energy machine, comprising means for causing balls to roll down along a slope from slow sliding inner descending small chain-belts so as to line-up along locked outer fast descending large chain-belts and means for causing an equal number of balls to roll down along a slope from fast sliding outer ascending large chain-belts so as to line-up along locked slow ascending small inner chain-belts, wherein constant imbalance machine will be created between the fast descending outer balls and the slow ascending inner balls.

27. The climate friendly energy machine as in claim 26, wherein the constant imbalanced machine includes enclosed-housings in a gap between two sets of inner pulleys and around the spindles, wherein each enclosed-housing has corridors, wherein a ball in each corridor, wherein each side of each enclosed-housing is connected to the outer and inner sliders, wherein each enclosed-housing is positioned into downward slope by the fast rotating outer chains, wherein equal balls are lined-up along the locked descending outer chains and along the locked ascending inner chains, wherein the constant imbalanced energy machine will be created.

28. The climate friendly energy machine as in claim 27, wherein the imbalanced machine could include a third spindle between the two high and low spindles with two large sprocket wheels and two small sprocket wheels, wherein one large sprocket between each of the large outer chains and one small sprocket between each of the small inner chains in order to support the chains in the parallel forms during rotations.

29. Energy machine for converting potential energy of fast descending outer weights that elevate slow ascending inner weights into rotational energy, comprising a frame two spindles four large wheels four small wheels four large slider-wheels four small slider-wheels four large belts four small belts four large chain-belts four small chain-belts multiple enclosed-housings containing water and multiple very small slider-ratchet-sprockets.

30. The energy machine for converting potential energy of fast descending outer weights that elevate slow ascending inner weights into rotational energy, wherein one spindle held high and one spindle held low by the frame, wherein a set of one large slider-wheel one large wheel one small slider-wheel and one small wheel riding on each end of each spindle, wherein one respective belt around each respective pair of wheels, wherein one respective chain-belt mounted on and around each respective belt, wherein one slider-ratchet-sprocket in each respective chain-link and connected to the respective slider-chain-belt, wherein each enclosed-housing along the wide gap around the middle section of the spindles, wherein each end of each enclosed-housing is connected to the respective pair of inner and outer slider-ratchet-sprockets, wherein as the outer ratchet-sprockets lock on and with the outer enclosed-housings force the outer chain-belts to descent fast the inner ratchet-sprockets unlocked and slide on the inner slow descending chain belts, wherein as the inner ratchet-sprockets lock on the inner slow ascending chain-belts to lift the inner enclosed-housings the outer fast ascending ratchet-sprockets are unlocked and slide on the fast ascending outer chain-belts.

31. Generator's engine, comprising two horizontal shafts and a set of four pulleys at each end of each of the shafts that are held by a frame along vertical line to provide wide gap around the middle section of the shafts where multiple weights could land and rotate around the shafts, wherein the pulleys in each set are riding the end of each shaft, wherein first the large outer slider-pulley, wherein second the large outer pulley, wherein third the small inner slider-pulley, wherein fourth the small inner pulley, wherein v-belt fitted around each pair of two pulleys which are along vertical line, wherein one chain fitted around each v-belt, wherein multiple ratchet-slider-sprockets are connected to the large outer slider-chains with two teeth of each ratchet-slider-sprocket in each two links of the large outer pair of chains, wherein multiple ratchet-slider-sprockets are connected to the small inner slider-chains with two teeth of each ratchet-slider-sprocket in each two links of the small inner pair of chains, wherein all the chains are ratchet-chains, wherein one rod inserted through the center of each pair of the outer sprockets, wherein one rod inserted through the center of each pair of the inner sprockets, wherein the rods are free to turn, wherein multiple parallel strings connecting the two rods like a screen, wherein there are multiple screens, wherein one weight riding each string, wherein the weights land when half of the screens turn from outer downward slope to inner downward slope at the same time the other half of the screens turn from the inner downward slope to outer downward slope and vice-versa every 180 degrees rotation.

32. The generator's engine as in claim 31, wherein as the outer descending ratchet-chains get locked and forced to descend fast with their landed and lined-up weights the inner descending ratchet chains get unlock and slide, wherein at the same time the fast ascending outer chains gets unlocked and slide so as to leave behind the inner chains to ascend with their landed and lined-up weights, wherein the weights are lining-up in equal number along the outer chains and along the inner chains since each descending screen when crossing the bottom point of vertical line the fast rotating outer chains together with the inertia of the bottom outer weights cause each fast descending screen to pivot into downward slope high at the fast sliding and ascending outer chains and down toward the locked slow ascending inner chains, wherein the respective weights land from the fast sliding and ascending outer chains so as to line-up along the locked slow ascending inner chains, wherein at the same time each of the slow ascending screens crosses the top point of the same vertical line and pivot into downward slope high at the slow sliding inner descending chains and down to the locked fast descending outer chains by the proclivity of the fast rotating outer chains to act in collaboration with the low center of gravity of the top screen, wherein the respective weights land from the slow sliding inner descending chains so as to line-up along the locked fast descending outer chains, wherein the number of weights along the locked fast descending outer chains is always equal to the number of weights along the locked slow ascending inner chains, wherein an inevitable natural constant imbalance is created that forces the weights into continual rotation in one direction after overcoming any expected frictions.
